(19) United States
(12) Patent Application Publication
(10) Pub. No.: US 2020/0337508 A1
(43) Pub. Date: Oct. 29, 2020

(54) DRYER AND COMBUSTOR FOR TOILET AND OPERATION THEREOF

(71) Applicant: CRANFIELD UNIVERSITY, Bedfordshire (GB)

(72) Inventors: Bhavin ENGINEER, Cambridgeshire (GB); Athanasios KOLIOS, Milton Keynes (GB); Tosin Olumayowa SOMORIN, Bedfordshire (GB); Leon WILLIAMS, Bedfordshire (GB)

(21) Appl. No.: 16/757,027

(22) PCT Filed: Oct. 19, 2018
(86) PCT No.: PCT/EP2018/078803

§ 371 Date: Apr. 17, 2020

(30) Foreign Application Priority Data
Oct. 19, 2017 (GB) 1717183.6

(51) Int. Cl. A47K 11/02; F26B 5/14

(52) U.S. Cl. CPC A47K 11/023; F26B 5/14

(57) ABSTRACT

In the treatment of human faeces having a starting moisture content, the faeces are pressed between opposing pressing surfaces of rollers in a dryer, to press out at least some moisture from the faeces. The pressing surfaces are moved to leave an exposed layer of pressed faeces on at least one of the pressing surfaces which is then scraped. This produces partially-treated human faeces having a moisture content of not more than 20 wt %. The partially-dried human faeces may then be combusted. This fuel is fed substantially continuously into a combustor at a rate of 0.4-15 g/min combusted continuously over a time of at least 1 hour. In the combustor, there is a reaction chamber with a drying zone and a first combustion zone. The reaction chamber is orientable to permit gravity-assisted transit of the fuel from the drying zone to the first combustion zone. The drying zone has a drying zone grate configured to hold some of the fuel while combustion of other of the fuel occurs at the first combustion zone. A toilet may incorporate such a dryer and/or combustor.

### BACKGROUND TO THE INVENTION

### Field of the Invention

The present invention relates to a dryer and to a combustor, each for use with a toilet, and the invention also relates to the operation of such devices (preferably together) in the context of a toilet. The invention is particularly, but not exclusively, suitable for use at locations with little or no available power and/or sewage infrastructure, such as in some developing countries and/or in remote locations.

### Related Art

Existing dry toilets, such as pit latrines and composting toilets, are often used in developing countries. They can be dug or manufactured without the need for specialist equipment, but produce unpleasant miasma. They are also unhygienic and unsanitary to use.

Existing chemical toilets provide some improvements over dry toilets, but still produce unpleasant odours and still suffer from hygiene and sanitation problems. Chemical toilets typically are emptied by hand, and the chemicals used can be harmful to the person emptying the toilet. Furthermore, chemical toilets can be expensive to install, and the chemicals used can be expensive to dispose of and replenish. The chemicals used can also be harmful to the environment if not disposed of correctly.

To spread the costs associated with installing and maintaining toilets in developing countries, toilets are often shared by many people. This sharing contributes to hygiene and sanitation problems. Furthermore, because of the unpleasant odour associated with such toilets, they tend to be in remote locations, rather than being in or close to homes. As such, people may have to walk a long way to access their nearest toilet, further decreasing the incentive to use a communal toilet.

It would therefore be desirable to provide a toilet that is inexpensive to purchase, install and maintain, whilst being capable of shielding the user from odour associated with the simple toilet solutions discussed above. In this way, it is preferred to develop a toilet that can be installed in a home, intended for the use of the occupiers of that home, which has no need of coupling to a sewer or a running water supply. Furthermore, it is particularly desirable to develop a toilet that is capable of processing human waste to avoid the need for the user periodically to empty unprocessed human waste, either from the toilet itself or from a storage container.

### SUMMARY OF THE INVENTION

The present invention has been devised in order to address at least one of the above problems. Preferably, the present invention reduces, ameliorates, avoids or overcomes at least one of the above problems.

The present invention addresses issues surrounding the treatment of human waste received in a toilet. Such waste typically comprises faeces and urine. Rough separation of these components can be achieved in a settling tank, for example, in the toilet, and these roughly separated components can be treated separately. The treatment of the urine component is not considered in detail here. The present invention therefore considers the treatment of faeces in the toilet.

It is desirable to treat the faeces by combustion. This is advantageous because it addresses issues of odour and hygiene. Furthermore, as the present inventors have realised, provided that the faeces are pre-treated to reduce the water content of the faeces, faeces can provide an adequate fuel to allow combustion to be self-sustaining. Furthermore, waste heat from the combustion can have useful applications elsewhere in the toilet, assisting the overall efficiency of operation of the toilet.

In a first development of the present invention, therefore, steps are taken in order to reduce the water content of the human faeces received in the toilet.

Accordingly, in a first preferred aspect of the first development of the invention, there is provided a process for the treatment of human faeces including the steps:

providing human faeces, having a starting moisture content, to a dryer;
pressing the faeces between opposing pressing surfaces in the dryer, to press out at least some moisture from the faeces;
moving the pressing surfaces to leave an exposed layer of pressed faeces on at least one of the pressing surfaces; and
scraping said at least one pressing surface to scrape off pressed faeces;
the dryer producing partially-treated human faeces having a moisture content of not more than 20 wt % based on the weight of the partially-treated human faeces.

In a second preferred aspect of the first development of the invention, there is provided a dryer for the treatment of human faeces, the dryer comprising:

opposable pressing surfaces configured to press out at least some moisture from the faeces and movable to leave an exposed layer of pressed faeces on at least one of the pressing surfaces; and
at least one scraper configured to scrape said at least one pressing surface to scrape off pressed faeces.

Preferably, the dryer reduces the moisture content of the faeces to not more than 20 wt % based on the weight of the pressed faeces.

In a third preferred aspect of the first development of the invention, there is provided a toilet having:

a settling tank for receiving human waste and allowing at least partial separation of faeces from urine;
a conveyer for moving faeces from the settling tank; and
a dryer according to the second aspect of the first development for receiving faeces from the conveyer and at least partially drying the faeces.

In a fourth preferred aspect of the first development of the invention, there is provided a method of operating a toilet according to the third aspect of the first development, the method including the steps of:

the settling tank receiving human waste and at least partially separating faeces from urine;
moving faeces from the settling tank to the dryer; and
at least partially drying the faeces in the dryer.

The dryer may produce pressed faeces substantially continuously at a rate of at least 0.4 g/min., preferably at least 1 g/min. Preferably, the dryer produces pressed faeces substantially continuously at a rate of at most 15 g/min. The pressed faeces may also be referred to herein as “partially-treated faeces”.

The opposing pressing surfaces of the dryer may be provided by one or more rollers. Preferably, there are two opposed rollers that counter-rotate relative to each other. The rollers may be heatable. For example, in operation, the rollers may be heated internally. Suitably, waste heat from elsewhere in the toilet (e.g. from the combustor disclosed below) may be used to heat the rollers.

The rollers are preferably substantially cylindrical. They may have axes of rotation that are substantially parallel to each other. In operation, preferably the axes of rotation are substantially horizontally oriented. Typically, the axes of rotation may be disposed at substantially the same vertical position, so that the rollers rotate side-by-side.

In operation, there is preferably a non-zero distance between the roller surfaces at their closest point of approach. This is referred to as a roller gap. Preferably the roller gap is at least 1 mm. Preferably the roller gap is at most 5 mm. More preferably, the roller gap is about 2 mm. It has been found that such a gap is suitable to provide adequate pressing of the faeces and yet still allows suitable throughput of faeces and provides a barrier and regulator for faeces flow. Pressing of the faeces in the roller gap presses at least some moisture out of the faeces. The position of the roller gap is preferably located on a notional line between the axes of rotation of the rollers.

Preferably, the faeces are conveyed from the settling tank to the dryer in a manner so that the faeces are received at an upper part of the dryer. The faeces may then be fed into an input of the rollers, preferably from above. The rollers preferably rotate in a direction so that, from above, the faeces is drawn into the roller gap both by gravity and by the relative movement of the rollers.

In use, it is found that the faeces are pressed at the roller gap. Beyond the roller gap, the opposing surfaces of the rollers move apart from each other, due to the rotation of the rollers. This is found to produce a tearing effect on the faeces, to leave a layer of faeces typically on each roller surface. This is found to provide particularly suitable conditions for further drying of the faeces. The depth of the layer of faeces on each roller is preferably not more than ten times the roller gap, or preferably not more than five times the roller gap, or not more than twice the roller gap. Note that the tearing of the faeces as the rollers separate may at least slight expand the faeces compared with the point of maximum compression of the faeces at the roller gap.

In operation, the rollers rotate relatively slowly. For example, the rollers may rotate at not more than 20 rotations per hour, more preferably not more than 10 rotations per hour, more preferably not more than 5 rotations per hour. The rollers may rotate at more than 0.1 rotations per hour. For example, rotation at about 1 rotation per hour is found to be suitable.

The dryer may include a dryer chamber, housing the rollers. In operation, hot gas, such as hot air, is preferably ducted into the dryer chamber. This is typically in addition to hot air that may be provided internally to the rollers to heat the rollers. The hot air assists the layer of faeces on the rollers to further dry by evaporation. The evaporated moisture may be ducted out of the dryer chamber to an exhaust.

Preferably, each roller has an associated scraper. As explained above, the purpose of the scraper is to scrape the layer of pressed faeces from the surface of the roller. Preferably, the scrapers are urged against the surfaces of the rollers. This helps to accommodate wear. For example, the scrapers may be spring loaded to bear against the roller surfaces. The position of the scraper on a roller is preferably such that the layer of faeces travels a suitable distance with the roller, to allow adequate drying. Preferably, therefore, the scraper is located on a roller at least a quarter turn from the roller gap, in the direction of rotation of the roller. More preferably, the scraper is located on a roller at least a half turn from the roller gap, in the direction of rotation of the roller.

The dryer chamber preferably has a faeces collection zone, located at a base portion of the dryer chamber. Preferably, the dryer chamber has at least one guide wall which slopes from a side wall towards the faeces collection zone. The purpose of the guide wall is to allow faeces that are scraped from the roller surface to be guided towards the faeces collection zone. There may be two or three such sloping guide walls, allowing the faeces collection zone to allow the concentration of collection of the faeces. This is suitable to allow onwards conveyance of the dried faeces from the faeces collection zone to the combustor (described below) using a screw conveyer, for example, with the screw conveyor picking up the dried faeces directly from the faeces collection zone.

Preferably, in operation, the hot air provided to the dryer has a temperature of at least 80° C. More preferably, the temperature is at least 90° C. Still more preferably, the temperature is at least 100° C. For example, the temperature may be in the range of 100-120° C.

Preferably, the dryer chamber is thermally insulated. For example, one or more layers of thermal insulation may be provided externally of the dryer chamber. As will be understood, this allows the dryer to use the heat provided to it more effectively to dry the faeces.

Disposed below the roller gap within the dryer chamber may be a liquids tray. This is disposed in order to catch liquid drops pressed from the faeces. The liquids tray may take the form of a gutter. Preferably, the gutter slopes from the dryer chamber, to allow the liquid to be conducted out of the dryer. The liquid may be conducted to the settling tank, for example.

The faeces input to the dryer may have a moisture content of not less than 50% by weight. For example, the moisture content may be about 80% by weight, but can be higher in some embodiments. Note that the moisture content is calculated based on the weight of moisture in wet faeces, i.e.:

Moisture content=[(wet weight-dry weight)/wet weight]

In a second development of the present invention, partially-treated human faeces are combusted. At the scale of a domestic toilet, one particular challenge is to operate a combustor at low fuel feed rates, where the fuel (partially-treated human faeces) may have a substantial moisture content. It is preferred to operate the combustor continuously or, if not continuously, over an extended period of time (e.g. at least 1 hour), in order that the number of instances of ignition required for the combustor are reduced as far as possible. This reduces or avoids the need for a separate source of fuel and/or power for ignition of the combustor. Furthermore, it is preferred to operate the combustor in a self-sustaining manner as far as possible, so that the fuel (partially-treated human faeces) sustains the combustion in the combustor.

Accordingly, in a first preferred aspect of the second development of the invention, there is provided a process for the treatment of human faeces, including the steps: providing a fuel comprising partially-treated human faeces, with a moisture content of not more than 20 wt % based on the weight of the partially-treated human faeces; introducing the fuel substantially continuously into a combustor at a rate of 0.4-15 g/min; and

combusting the fuel continuously over a time of at least 1 hour.

In a second preferred aspect of the second development of the invention, there is provided a combustor for the treatment of human faeces, the combustor being adapted to receive a fuel comprising partially-treated human faeces, with a moisture content of not more than 20 wt % based on the weight of the partially-treated human faeces and adapted to receive the fuel substantially continuously at a rate of 0.4-15 g/min, the combustor having a reaction chamber with a drying zone and a first combustion zone, wherein the reaction chamber is orientable to permit gravity-assisted transit of the fuel from the drying zone to the first combustion zone, wherein the drying zone has a drying zone grate configured to hold some of the fuel while combustion of other of the fuel occurs at the first combustion zone.

In a third preferred aspect of the second development of the invention, there is provided a toilet having:

a settling tank for receiving human waste and allowing at least partial separation of faeces from urine;
a conveyer for moving faeces from the settling tank;
a dryer for at least partially drying the faeces; and
   a combustor according to the second aspect of the second development, adapted to receive the partially dried faeces from the dryer and to combust the partially dried faeces.

In a fourth preferred aspect of the second development of the invention, there is provided a method of operating a toilet according to the third aspect of the second development, the method including the steps of:

the settling tank receiving human waste and at least partially separating faeces from urine;
moving faeces from the settling tank to the dryer;
at least partially drying the faeces in the dryer; and combusting the partially dried faeces from the dryer in the combustor.

Preferably, the drying zone grate is movable. It is preferred that the drying zone grate is capable of moving to deposit the fuel from the grate into the first combustion zone. Such transfer of the fuel may be batch-wise. For example, the drying zone grate may be capable of rotation about a rotation axis to tip the fuel from the drying zone grate into the first combustion zone.

Preferably, the combustor has a first combustion zone grate. This grate is preferably configured to hold fuel being combusted in the first combustion zone. In the first combustion zone, the fuel may be combusted and/or pyrolysed and/or gasified.

Preferably, the first combustion zone grate is movable. It is preferred that the first combustion zone grate is capable of moving to deposit the fuel from the grate into the second combustion zone. Such transfer of the fuel may be batch-wise. For example, the first combustion zone grate may be capable of rotation about a rotation axis to tip the fuel from the first combustion zone grate into the second combustion zone.

Preferably, the combustor further includes a second combustion zone. In use, the second combustion zone is disposed beneath the first combustion zone. The combustor preferably has a second combustion zone grate. This grate is preferably configured to hold fuel being combusted in the second combustion zone. In the second combustion zone, the fuel may be combusted and/or gasified and/or may be subjected to char burn. It is preferred that the fuel is fully combusted by the end of its time in the second combustion zone, in order to leave ash.

Preferably, the combustor further includes an ash collection zone. This may be disposed in operation beneath the second combustion zone.

Preferably, the second combustion zone grate is movable. It is preferred that the second combustion zone grate is capable of moving to deposit the ash from the grate into the ash collection zone. Such transfer of the ash may be batch-wise. For example, the second combustion zone grate may be capable of rotation about a rotation axis to tip the fuel from the second combustion zone grate into the ash collection zone.

In operation, it is preferred that the movement of the grates is controlled so that when the first combustion zone grate is open, the drying zone grate is closed. Similarly, it is preferred that when the second combustion zone grate is open, the first combustion zone grate is closed. This avoids unwanted transit of fuel directly from the drying zone to the second combustion zone, and/or unwanted transit of fuel directly from the first combustion zone to the ash collection zone.

The combustor is intended to be of small scale. This is of interest in terms of maintaining a small overall size for the toilet. However, more importantly, it is considered to be of assistance in promoting self-sustaining substantially continuous combustion based on the low feed rate of fuel available.

In some embodiments, the distance between the drying zone grate and the first combustion zone grate is not more than 100 mm. Similarly, it is preferred that the distance between the first combustion zone grate and the second combustion zone grate is not more than 100 mm.

The inner diameter of the reaction chamber at the first combustion zone is preferably not more than 60 mm. The inner diameter of the reaction chamber at the drying zone is preferably not more than 60 mm. The inner diameter of the reaction chamber at the second combustion zone is preferably not more than 60 mm. Where the cross sectional shape of the reaction chamber is non-circular, the diameter is to be assessed on the basis of the diameter of a circle of the same area as the cross sectional shape of the reaction chamber.

The reaction chamber of the combustor may comprise a ceramic body. Preferably, the ceramic body contains at least the first combustion zone and, if present, the second combustion zone. It is preferred that the ceramic body is formed from a ceramic material having a thermal conductivity which is relatively low, preferably lower than that of stainless steel, for example. This is in view of the need for the combustion to be self-sustaining but with only a slow fuel feed rate.

Combustion air may be provided to the reaction chamber from at or below the second combustion zone. This is then an “updraft” configuration. However, it is at present more preferred to adopt a “downdraft” configuration, in which the combustion air is provided to the reaction chamber from at or above the first combustion zone. Although the updraft configuration has some advantages in terms of assisting in the drying of the fuel at the drying zone, and therefore permits the fuel to have a high moisture content, a disadvantage is that the exhaust gas may contain substantial quantities of tar and/or oils that may clog. The downdraft configuration requires that the fuel has a relatively low moisture content (e.g. not more that 20 wt % moisture) but provides the advantages that the exhaust gas may have reduced tar and/or oils (due to cracking in the second combustion zone) and good char burn-out.

The combustor may be provided with an ignition system. The ignition system may have an independent heat source (e.g. a pre-heater) and/or an independent fuel source. The ignition system may be provided with a spark generator (e.g. spark plug). The provision of an ignition system allows the combustor to be started up. The ignition system may be provided in communication with the first combustion zone.

The combustor may have an exhaust gas outlet. The location of this with respect to the reaction chamber depends on whether the combustor has an updraft configuration or a downdraft configuration.

The combustor may include a sloping guide wall in the ash collection zone. This is intended to guide the ash falling from the second combustion zone towards an ash outlet. Preferably, the ash outlet is offset from the centre line of the reaction chamber. The intention here is to avoid ash from clogging the exit of exhaust gas from the reaction chamber, in particular when the combustor has a downdraft configuration.

Preferably, the first and second developments of the invention are provided together in combination. This therefore represents a third development of the invention.

Accordingly, in a first preferred aspect of the third development of the invention, there is provided a process for the treatment of human faeces, including the steps:

at least partially drying human faeces according to the first aspect of the first development of the invention to produce partially-treated human faeces;

combusting the partially-treated human faeces according to the first aspect of the second development.

In a second preferred aspect of the third development of the invention, there is provided a human faeces treatment apparatus comprising a dryer according to the second aspect of the first development operably linked to a combustor according to the second aspect of the second development.

In a third preferred aspect of the third development of the invention, there is provided a toilet having:

a settling tank for receiving human waste and allowing at least partial separation of faeces from urine;
a conveyer for moving faeces from the settling tank;
a dryer according to the second aspect of the first development operably linked to a combustor according to the second aspect of the second development.

In a fourth preferred aspect of the third development of the invention, there is provided a method of operating a toilet according to the third aspect of the third development, the method including the steps of:

the settling tank receiving human waste and at least partially separating faeces from urine;
moving faeces from the settling tank to the dryer;
at least partially drying the faeces in the dryer; and
combusting the partially dried faeces from the dryer in the combustor.

Preferably, heat from the combustor is transferred to the dryer. This may be achieved using a heat exchanger. Alternatively, hot exhaust gas from the combustor may be ducted to the dryer. This has the advantage of efficiently using excess heat from the combustor.

Partially-treated faeces may be transferred from the dryer to the combustor using a feed screw. This may be configured upright in use. The partially-treated faeces may be additionally treated by the feed screw, by being chopped to smaller particles and/or by being further dried.

The first, second, third and/or fourth aspect of any of the first, second and/or third development of the invention may be combined in any combination and/or may have any one or, to the extent that they are compatible, any combination of the optional features disclosed with respect to the first, second, third and/or fourth aspect of any of the first, second and/or third development of the invention.

Further optional features of the invention are set out below.

### BRIEF DESCRIPTION OF THE DRAWINGS

Embodiments of the invention will now be described by way of example with reference to the accompanying drawings in which:

FIG. 1 shows a schematic perspective view of a toilet according to an embodiment of the present invention.

FIG. 2 shows a side view of the dryer and combustor arranged with respect to each other.

FIG. 3 shows a perspective view of the arrangement of FIG. 2.

FIG. 4 shows an alternative perspective view of the arrangement of FIG. 2.

FIG. 5 shows a rear view of the arrangement of FIG. 2.

FIG. 6 shows a schematic cross sectional view through the dryer.

FIG. 7 shows a schematic view of a fuel feeding arrangement for use with a combustor.

FIG. 8 shows a schematic cross sectional view of a combustor.

### DETAILED DESCRIPTION OF THE PREFERRED EMBODIMENTS

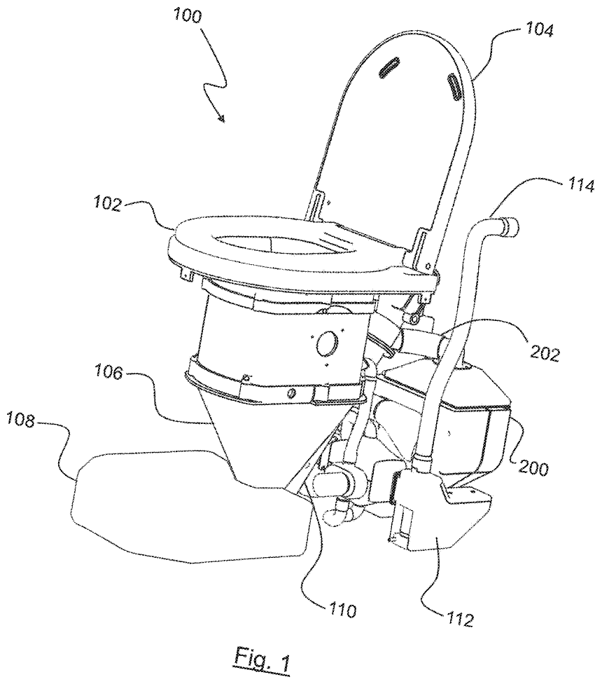

FIG. 1 shows a toilet 100 according to an embodiment of the present invention. As can be seen the drawing, the toilet is freestanding and has a compact design. It can be used without the need for an external electrical power supply, or an external source of water.

Toilet 100 has a seat 102 and lid 104. Human waste is deposited in the toilet and is transferred into setline tank 106. Urine is separated from the faeces and treated separately by filtration, which is not described here in detail, but the water filtered from the urine is stored in reservoir 108. Faeces is conveyed from the setting tank via screw 110 and transferred into dryer 200 at dryer inlet 202. The combustor is not visible in the view shown in FIG. 1. Water vapour condenser 112 is associated with the urine filtration system and has an exhaust 114.

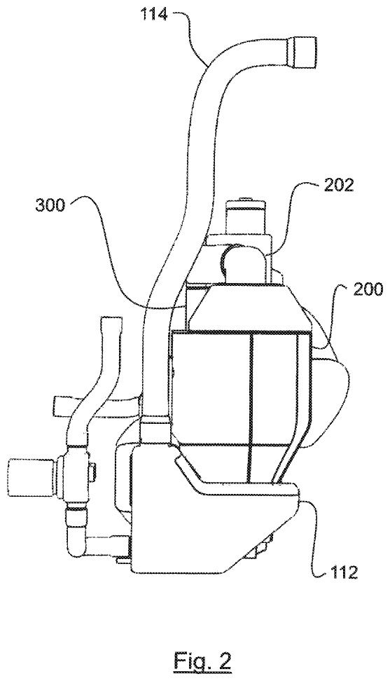

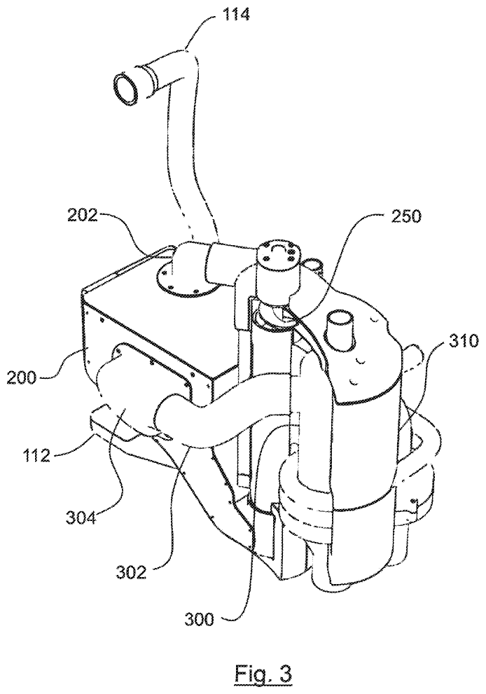

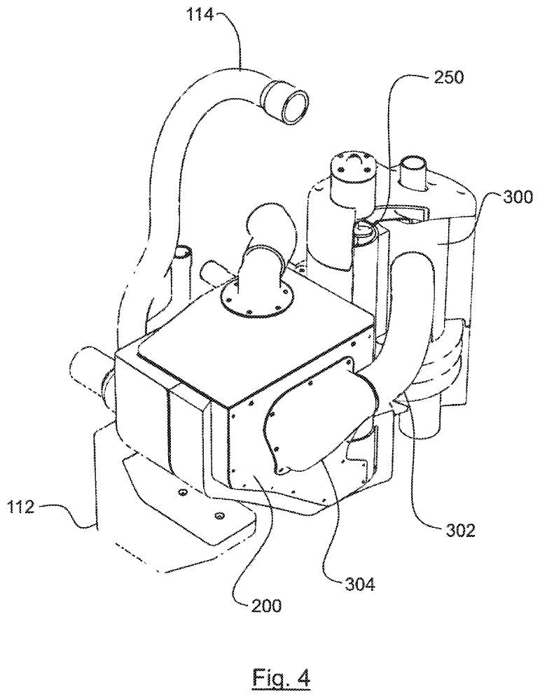

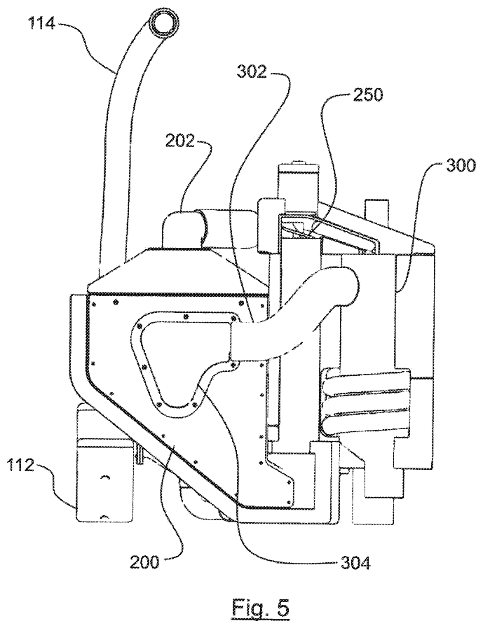

FIG. 2 shows a side view of the dryer 200 and combustor 300 arranged with respect to each other. FIG. 3 shows a perspective view of the arrangement of FIG. 2. FIG. 4 shows an alternative perspective view of the arrangement of FIG. 2. FIG. 5 shows a rear view of the arrangement of FIG. 2. These drawings are described together, with the same reference numbers used for similar features where appropriate.

Dryer 200 and combustor 300 are arranged side by side. Hot exhaust gas from the combustor is directed from the combustor along exhaust duct 302 to manifold 304. The hot gas is used in the dryer to heat the rollers (described later) and to provide a hot atmosphere in the dryer.

The faeces dried in the dryer collects at the base of screw conveyer 250. The faeces is therefore conveyed upwardly by screw conveyer 250 where is it additionally dried and chopped by the screw conveyer. It is then transferred under gravity in to the combustor 300. The view shown in the drawings is partially cutaway in order to show the heat insulation 310 and also to show the components held inside the heat insulation 310.

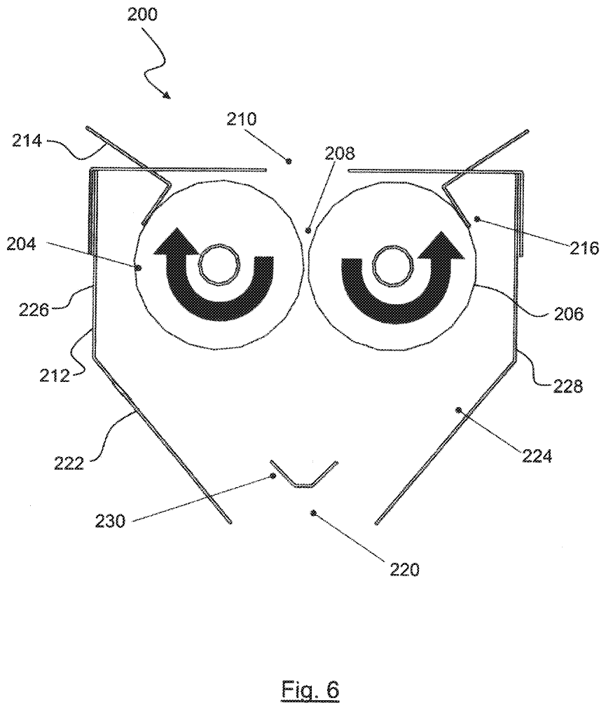

FIG. 6 shows a schematic cross sectional view through the dryer 200. It is intended that the dryer is capable of producing pressed faeces substantially continuously at a rate of 0.4-15 g/min, or 1-15 g/min. The pressed faeces may also be referred to herein as “partially-treated faeces”.

The opposing pressing surfaces of the dryer are provided by two opposed rollers 204, 206 that counter-rotate relative to each other, as shown by the thick arrows superimposed on the rollers. The rollers are heatable internally by ducting hot gas from the combustor into the interior of the rollers via manifold 304. As shown, the rollers are cylindrical and have axes of rotation that are parallel to each other and are horizontally oriented and disposed at substantially the same vertical position, so that the rollers 204, 206 rotate side-by-side.

Roller gap 208, i.e. the non-zero distance between the roller surfaces at their closest point of approach, is about 2 mm. It has been found that such a gap is suitable to provide adequate pressing of the faeces and yet still allows suitable throughput of faeces and provides a barrier and regulator for faeces flow. Pressing of the faeces in the roller gap presses at least some moisture out of the faeces.

The faeces are fed via inlet 210 to the rollers, from above. The rollers rotate in a direction so that, from above, the faeces is drawn into the roller gap both by gravity and by the relative movement of the rollers.

In use, it is found that the faeces are pressed at the roller gap. Beyond the roller gap, the opposing surfaces of the rollers move apart from each other, due to the rotation of the rollers. This is found to produce a tearing effect on the faeces, to leave a layer of faeces on each roller surface. This is found to provide particularly suitable conditions for further drying of the faeces.

In operation, the rollers rotate relatively slowly. For example, the rollers may rotate at about 1 rotation per hour.

The dryer includes a dryer chamber 212, housing the rollers. In operation, hot air is ducted into the dryer chamber via manifold 304. This is in addition to hot air that is provided internally to the rollers to heat the rollers. The hot air assists the layer of faeces on the rollers to further dry by evaporation. The evaporated moisture is ducted out of the dryer chamber to an exhaust.

Each roller has an associated scraper 214, 216. The purpose of the scraper is to scrape the layer of pressed faeces from the surface of the roller. The scrapers are urged via spring loading against the surfaces of the rollers. This helps to accommodate wear. The position of the scraper on a roller is such that the layer of faeces travels a suitable distance with the roller, to allow adequate drying. In this embodiment, this distance is the equivalent of more that a half turn from the roller gap, in the direction of rotation of the roller.

The dryer chamber has a faeces collection zone 220, located at a base portion of the dryer chamber 212. The dryer chamber has guide walls 222, 224 which slope from side walls 226, 228 towards the faeces collection zone 220. The purpose of the guide walls is to allow faeces that are scraped from the roller surface to be guided towards the faeces collection zone 220. The screw conveyor 250 picks up the dried faeces directly from the faeces collection zone 220.

The dryer chamber is thermally insulated via layers of thermal insulation (not shown).

Disposed below the roller gap 208 within the dryer chamber is a liquids tray 230. This is disposed in order to catch liquid drops pressed from the faeces. The liquids tray may take the form of a gutter. The gutter slopes from the dryer chamber, to allow the liquid to be conducted out of the dryer. The liquid may be conducted to the settling tank. It is possible in some embodiments to provide means for conveying the contents of the tray (or other receptacle for catching liquids and possibly also some solids from the rollers). For example, a screw conveyor may be disposed to draw off liquids and any solids that fall into the tray. The screw may be at least partially in the same plane as the rollers and may be driven by a belt or gear from the rollers themselves.

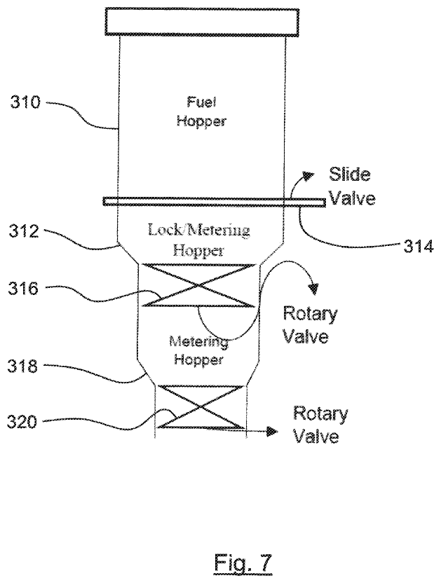

FIG. 7 shows a schematic view of a fuel feeding arrangement for use with a combustor. This is found to be of use in particular in developing the preferred combustor configuration. However, in the preferred embodiment in which the dryer and the combustor are combined, this fuel feed arrangement may be substituted by the screw conveyer described above.

In FIG. 7, a fuel hopper 310 contains the partially-treated faeces. Below fuel hopper 310 is a lock/metering hopper 312 with a slide valve 314 interposed between them. At the base of the lock/metering hopper 312 is a rotary valve 316 which is rotatable to conduct the fuel into a metering hopper 318. Metering hopper 318 has a further rotary valve 320 to permit metering of the fuel into the combustor. The intention of this arrangement is to reduce the tendency of the fuel to bridge across the fuel inlet system, or to cake within it.

Further below, we discuss the specific structure and operation of the combustor. However, it is first useful to discuss some further background to aid understanding of the context of the present disclosure.

The development of alternative sources of energy and the need to protect the environment is changing our perspectives on the way natural resources are utilized and waste is managed. Materials such as municipal solid waste, agricultural residues and sewage sludge that were traditionally considered as waste, and either burnt or discarded into landfills, may now be regarded as feedstocks for bioenergy (Huang and Rein, 2016; Milani et al., 2014; Nussbaumer, 2003; Werle et al., 2016). Human faeces are one of such biomass resources with potential to be used as fuel and converted to heat and/or electricity (T. Onabanjo et al., 2016a).

The ‘Reinvent the Toilet Challenge’ funded by the Bill & Melinda Gates Foundation was launched to improve access to affordable, safe and sustainable sanitation while simultaneously utilising the chemical energy contained in the human faeces. The challenge aims to develop innovative household-scale toilets that treat human excreta and recover useful resources at affordable price without producing hazardous products (Bill & Melinda Gates Foundation, 2016a, 2016b; McConville et al., 2014; Parker, 2014).

The present inventors have approached this challenge by aspiring towards self-sustained operation of a toilet by valorising the faeces without the need for external energy supply. The thermodynamic analysis conducted by the inventors' research group (Hanak et al., 2016) shows the possibility of self-sustained operation and also indicates the need for the efficient management of the energy recovered from the human faeces.

Onabanjo et al. (T. Onabanjo et al., 2016a) and Muspratt et al. (Muspratt et al., 2014) showed that human faeces have a comparable and, in some instances, higher heat value than wood biomass (both on the dry basis). This chemical energy can be recovered via thermochemical conversion technologies including smouldering (Wall et al., 2015; Yerman et al., 2015), combustion (Monhol and Martins, 2015; T. Onabanjo et al., 2016a), hydrothermal carbonization (Afolabi et al., 2015; Danso-Boateng et al., 2013), and pyrolysis (Ward et al., 2014).

Combustion presents a significant opportunity for energy recovery in the context of a toilet because of the heat released during the process at temperatures ranging from as low as 250° C. (smouldering) to >1000° C. (combustion), depending on air excess, ignition modes (standard vs. booster), fuel composition, etc. The released heat can be used for removing moisture from fresh human faeces in the dryer, described above, before it is fed into micro-combustor (T. Onabanjo et al., 2016b). Contrary to other thermochemical processes such as pyrolysis and hydrothermal treatment, combustion is mature and widely applied process; thereby, increasing its potential application for sanitary solutions where affordability is a priority, particularly for developing countries. For a domestic-scale toilet, a continuous mode of operation of the micro-combustor would be desirable to limit energy requirement for ignition and to ensure that the bed material is sufficiently hot for incoming partly-moist faecal material.

Work from the present inventors' research group using a bench-scale reactor (T. Onabanjo et al., 2016b) showed the feasibility of combustion of faeces; however, the need for controlled air supply for self-sustained ignition and flame propagation was emphasised. The paper also highlighted the desirability for removing the ash, and so the present disclosure proposes an embodiment with a regulated ash removal system, that can prevent the build-up of ash in the combustion zone but in sufficient amount to retain heat for continuous thermal treatment. To ensure the safety of the users and minimise heat losses, which increases thermal efficiency, special attention was paid to material selection for the micro-combustor in the preferred embodiment. It is also considered that some scales of reactor may have too high a capacity (e.g. even the range of 1.5-2.3 g/min may be too large for a toilet designed for a single household with ten user capacity) and therefore special attention should be paid to ensuring that the combustor can operate at lower faeces burn rate, e.g. at about 0.4 g/min (T. Onabanjo et al., 2016a). A flexible mode of operation is also desirable to accommodate different toilet user capacities, faeces generation rate, and lifestyle such as vacation from home.

The justification for designing a new a prototype for combustion of human faeces was based on results from previous experimental studies carried out with a bench scale facility (T. Onabanjo et al., 2016b), designed at RTI International/Colorado State University and tested at Cranfield University. This new design was needed considering to be used by a smaller community (which will affect the scale of the system) and aims to use a continuous combustion process, in opposite to the batch operation performed previously. Thus, the focus of this disclosure is a micro-combustor system that is suitable for the thermochemical conversion of human faeces and for continuous, or substantially continuous, self-sustained operation in the context of a toilet.

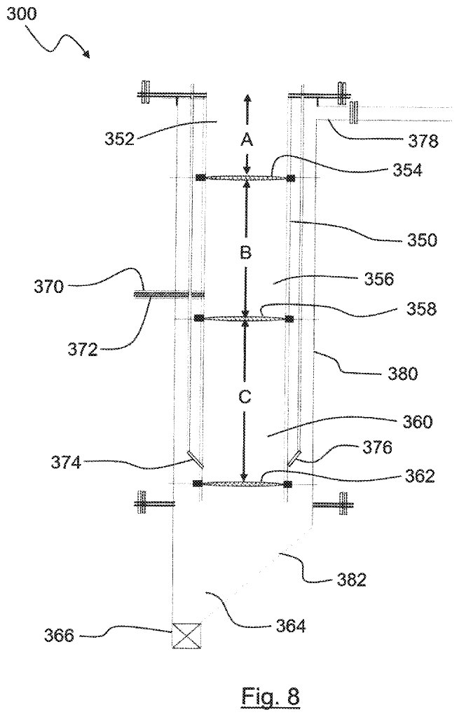

Returning now to a discussion of the preferred embodiments, FIG. 8 shows a longitudinal cross sectional view of a combustor 300.

The combustor receives a fuel (not shown) comprising partially-treated human faeces from the dryer. The combustor has reaction chamber 350 formed from a machinable ceramic material. A drying zone 352 is formed above drying zone grate 354. First combustion zone 356 is formed above first combustion zone grate 358. In view of the vertical orientation of the reaction chamber 350, gravity-assisted transit of the fuel from the drying zone to the first combustion zone is permitted. When fuel is combusted at first combustion zone 356, fuel held at the drying zone grate is further dried. In the first combustion zone, the fuel may be combusted and/or pyrolysed and/or gasified.

The drying zone grate 354 is movable by rotation to deposit the fuel from the grate into the first combustion zone 356.

Similarly, the first combustion zone grate 358 is movable by rotation to deposit the fuel from the grate into second combustion zone 360, which has second combustion zone grate 362. The second combustion zone is disposed beneath the first combustion zone. In the second combustion zone, the fuel is combusted and/or gasified and/or may be subjected to char burn. It is preferred that the fuel is fully combusted by the end of its time in the second combustion zone, in order to leave ash.

The combustor further includes ash collection zone 364. This is disposed in operation beneath the second combustion zone 360. The second combustion zone grate is capable of moving by rotation to deposit the ash from the grate into the ash collection zone 364. Ash collection zone has ash port 366 to allow emptying of ash from the combustor.

In operation, the movement of the grates 354, 358, 362 is controlled so that when the first combustion zone grate 354 is open, the drying zone grate is closed. Similarly, it is preferred that when the second combustion zone grate is open, the first combustion zone grate is closed. This avoids unwanted transit of fuel directly from the drying zone to the second combustion zone, and/or unwanted transit of fuel directly from the first combustion zone to the ash collection zone.

The combustor is of small scale. This is of interest in terms of maintaining a small overall size for the toilet. However, more importantly, it is considered to be of assistance in promoting self-sustaining substantially continuous combustion based on the low feed rate of fuel available. In FIG. 8, distance A is about 45 mm, distance B is about 70 mm and distance C is about 70 mm. The internal diameter of the reaction chamber 350 is about 40 mm.

Combustion air is fed into the reaction chamber at air inlet 370. Heater 372 is provided to heat the combustion air, particularly during ignition. As can be seen in FIG. 8, the combustion air is fed into the first combustion zone 356, and so the combustor has a downdraft configuration. Secondary air is provided via secondary air inlets 374, 376, to the second combustion zone 360. This assists with char burn-out.

In this embodiment, the exhaust gas outlet 378 is provided at the upper end of the combustor. This has the advantage that ash entrained in the exhaust gas can fall back into the ash collection zone 364 from the annular exhaust passage 380 surrounding the reaction chamber 350 and communicating between the ash collection zone 364 and the exhaust gas outlet 378.

The ash collection zone has a sloping guide wall 382 to guide the ash falling from the second combustion zone, and/or from the annular exhaust passage 380, towards an ash outlet. The ash outlet 366 is offset from the centre line of the reaction chamber 350, to assist in preventing ash from clogging the exit of exhaust gas from the reaction chamber.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above and/or below are hereby incorporated by reference.

### LIST OF NON-PATENT DOCUMENT REFERENCES

Afolabi, O. O. D., Sohail, M., Thomas, C. P. L., 2015. Microwave Hydrothermal Carbonization of Human Biowastes. Waste and Biomass Valorization 6, 147-157. doi:10.1007/s12649-014-9333-4
Bill & Melinda Gates Foundation, 2016a. Reinvent the toilet—strategy overview [WWW Document]. URL http://www.gatesfoundation.org/What-We-Do/Global-Development/Reinvent-the-Toilet-Challenge
Bill & Melinda Gates Foundation, 2016b. Water, Sanitation & Higiene—Strategy Overview [WWW Document]. URL http://www.gatesfoundation.org/What-We-Do/Global-Development/Water-Sanitation-and-Hygiene
Danso-Boateng, E., Holdich, R. G., Shama, G., Wheatley, a. D., Sohail, M., Martin, S. J., 2013. Kinetics of faecal biomass hydrothermal carbonisation for hydrochar production. Applied Energy 111, 351-357. doi:10.1016/j.apenergy.2013.04.090
Grossman, D. G., 1978. Machining a machinable glass-ceramic. Vacuum 28, 55-61. doi:10.1016/50042-207X(78)80514-4
Hanak, D. P., Kolios, A. J., Onabanjo, T., Wagland, S. T., Patchigolla, K., Fidalgo, B., Manovic, V., McAdam, E., Parker, A., Williams, L., Tyrrel, S., Cartmell, E., 2016. Conceptual energy and water recovery system for self-sustained nano membrane toilet. Energy Conversion and Management 126, 352-361. doi:10.1016/j.enconman.2016.07.083
Huang, X., Rein, G., 2016. Thermochemical conversion of biomass in smouldering combustion across scales: The roles of heterogeneous kinetics, oxygen and transport phenomena. Bioresource Technology 207, 409-421. doi:10.1016/j.biortech.2016.01.027
McConville, J. R., Kunzle, R., Messmer, U., Udert, K. M., Larsen, T. a, 2014. Decision support for redesigning wastewater treatment technologies. Environmental Science & Technology 48, 12238-12246.
Milani, M., Montorsi, L., Stefani, M., 2014. An integrated approach to energy recovery from biomass and waste: Anaerobic digestion-gasification-water treatment. Waste management & research: the journal of the International Solid Wastes and Public Cleansing Association, ISWA 32, 614-625. doi:10.1177/0734242X14538307
Monhol, F. a F., Martins, M. F., 2015. Cocurrent Combustion of Human Feces and Polyethylene Waste. Waste and Biomass Valorization 6, 425-432. doi:10.1007/s12649-015-9359-2
Muspratt, a. M., Nakato, T., Niwagaba, C., Dione, H., Kang, J., Stupin, L., Regulinski, J., Mbéguéré, M., Strande, L., 2014. Fuel potential of faecal sludge: calorific value results from Uganda, Ghana and Senegal. Journal of Water, Sanitation and Hygiene for Development 4, 223. doi:10.2166/washdev.2013.055
Nussbaumer, T., 2003. Combustion and Co-combustion of Biomass: Fundamentals, Technologies, and Primary Measures for Emission Reduction. Energy and Fuels 17, 1510-1521. doi:10.1021/ef030031q
(a) Onabanjo, T., Kolios, A. J., Patchigolla, K., Wagland, S. T., Fidalgo, B., Jurado, N., Hanak, D. P., Manovic, V., Parker, A., Mcadam, E., Williams, L., Tyrrel, S., Cartmell, E., 2016. An experimental investigation of the combustion performance of human faeces. Fuel 184, 780-791. doi:10.1016/j.fuel.2016.07.077
(b) Onabanjo, T., Patchigolla, K., Wagland, S. T., Fidalgo, B., Kolios, a., McAdam, E., Parker, a., Williams, L., Tyrrel, S., Cartmell, E., 2016. Energy recovery from human faeces via gasification: A thermodynamic equilibrium modelling approach. Energy Conversion and Management 118, 364-376. doi:10.1016/j.enconman.2016.04.005
Parker, A., 2014. Membrane technology plays key role in waterless hygienic toilet. Membrane Technology 2014, 8. doi:10.1016/50958-2118(14)70255-1
Pawar, P., Ballav, R., Kumar, A., 2015. An Overview of Machining Process of Alumina and Alumina Ceramic Composites. Manufacturing Science and Technology 3, 10-15. doi:10.13189/mst.2015.030102
Pollution Research Group—University of KwaZulu-Natal, 2014. Selection of synthetic sludge simulant for the Bill and Melinda Gates Foundation's Reinvent the Toilet Fair. India.
PSEC University of Chicago, n.d. Physical and mechanical properties of Kovar.
Shirzadi, A., 2008. Solid-state diffusion bonding. Elsevier Ltd, pp. 234-249. doi:10.1533/9781845694043.2.234
Wall, H., Gerhard, J., Fabris, I., Cormier, D., Cheng, Y. L., Torero, J. L., 2015. Investigation of self-sustaining smouldering of faeces: Key parameters and scaling effects, in: Dynamic Ecolibrium: Sustainable Engineering Society Conference (SENG 2015). pp. 113-121.
Ward, B. J., Yacob, T. W., Montoya, L. D., 2014. Evaluation of solid fuel char briquettes from human waste. Environmental Science and Technology 48, 9852-9858. doi:10.1021/es500197h
Werle, S., Dudziak, M., Grübel, K., 2016. Indirect methods of dried sewage sludge contamination assessments. Journal of environmental science and health. Part A, Toxic/hazardous substances & environmental engineering 4529, 1-5. doi:10.1080/10934529.2016.1170449
Yerman, L., Hadden, R. M., Carrascal, J., Fabris, I., Cormier, D., Torero, J. L., Gerhard, J. I., Krajcovic, M., Pironi, P., Cheng, Y. L., 2015. Smouldering combustion as a treatment technology for faeces: Exploring the parameter space. Fuel 147, 108-116. doi:10.1016/j.fuel.2015.01.055
Zhang, C., Qiao, G., Jin, Z., 2002. Active brazing of pure alumina to Kovar alloy based on the partial transient liquid phase (PTLP) technique with Ni—Ti interlayer. Journal of the European Ceramic Society 22, 2181-2186. doi:10.1016/50955-2219(02)00011-0
Zhao, M., Han, Z., Sheng, C., Wu, H., 2013. Characterization of Residual Carbon in Fly Ashes from Power Plants Firing Biomass. Energy & Fuels 27, 898-907. doi:10.1021/ef301715p

1-18. (canceled)

19. A process for the treatment of human faeces, including the steps:
providing a fuel comprising partially-treated human faeces, with a moisture content of not more than 20 wt % based on the weight of the partially-treated human faeces;
introducing the fuel substantially continuously into a combustor at a rate of 0.4-15 g/min; and
combusting the fuel continuously over a time of at least 1 hour.

20. The process according to claim 19 wherein the drying zone grate is moved to deposit the fuel from the drying zone grate into the first combustion zone.

21. The process according to claim 19 wherein the combustor has a first combustion zone grate, the grate holding fuel being combusted in the first combustion zone.

22. The process according to claim 21 wherein the first combustion zone grate is moved to deposit the fuel from the grate into a second combustion zone, disposed beneath the first combustion zone.

23. The process according to claim 22 wherein the combustor has a second combustion zone grate holding fuel being combusted in the second combustion zone.

24. The process according to claim 23 wherein the combustor further includes an ash collection zone disposed in operation beneath the second combustion zone, and wherein the second combustion zone grate is moved to deposit the ash from the second combustion zone grate into the ash collection zone.

25. The process according to claim 24 wherein the movement of the grates is controlled so that when the first combustion zone grate is open, the drying zone grate is closed, and/or so that when the second combustion zone grate is open, the first combustion zone grate is closed.

26. A combustor for the treatment of human faeces, the combustor being adapted to receive a fuel comprising partially-treated human faeces, with a moisture content of not more than 20 wt % based on the weight of the partially-treated human faeces and adapted to receive the fuel substantially continuously at a rate of 0.4-15 g/min, the combustor having a reaction chamber with a drying zone and a first combustion zone, wherein the reaction chamber is orientable to permit gravity-assisted transit of the fuel from the drying zone to the first combustion zone, wherein the drying zone has a drying zone grate configured to hold some of the fuel while combustion of other of the fuel occurs at the first combustion zone.

27. The combustor according to claim 26 wherein the drying zone grate is configured to be moveable to deposit the fuel from the drying zone grate into the first combustion zone.

28. The combustor according to claim 26 or claim 27 having a first combustion zone grate for holding fuel being combusted in the first combustion zone.

29. The combustor according to claim 28 wherein the first combustion zone grate is configured to be moveable to deposit the fuel from the grate into a second combustion zone, disposable in operation beneath the first combustion zone.

30. The combustor according to claim 29 wherein the combustor has a second combustion zone grate for holding fuel being combusted in the second combustion zone.

31. The combustor according to claim 30 having an ash collection zone disposed in operation beneath the second combustion zone, and wherein the second combustion zone grate is configured to be moveable to deposit the ash from the second combustion zone grate into the ash collection zone.

32. A toilet having:
a settling tank for receiving human waste and allowing at least partial separation of faeces from urine;
a conveyer for moving faeces from the settling tank;
a dryer for at least partially drying the faeces to produce partially-treated human faeces; and
a combustor, the combustor being adapted to receive a fuel comprising said partially treated human faeces, with a moisture content of not more than 20 wt % based on the weight of the partially-treated human faeces and adapted to receive the fuel substantially continuously at a rate of 0.4-15 g/min, the combustor comprising a reaction chamber with a drying zone and a first combustion zone, wherein the reaction chamber is orientable to permit gravity-assisted transit of the fuel from the drying zone to the first combustion zone, wherein the drying zone has a drying zone grate configured to hold some of the fuel while combustion of other of the fuel occurs at the first combustion zone.

33-38. (canceled)
